(19) United States
(12) Patent Application Publication
(10) Pub. No.: US 2012/0251241 A1
(43) Pub. Date: Oct. 4, 2012

(54) HAND OPERATED VIBRATORY MACHINE WITH VIBRATION DAMPENING HANDLE MOUNT

(75) Inventor: Tandrea Sperfslage, West Bend, WI (US)

(73) Assignee: Wacker Neuson Production Americas LLC

(21) Appl. No.: 13/078,137

(22) Filed: Apr. 1, 2011

(51) Int. Cl. E01C 19/38; F16F 15/04

(52) U.S. Cl. 404/114; 267/136

(57) ABSTRACT

A vibration generating machine and method of use is provided. The vibration generating machine includes a work piece such as screed blade and a vibration generator for imparting vibrations to the work piece. The machine is guided by a handle mounted on the work piece by a monolithic handle mount. The monolithic handle mount includes a lower section for mounting directly or indirectly to the work piece, an upper section at least indirectly supporting a handgrip, and an intermediate section having a partial coil that reduce the transmission of vibrations therethrough.

### BACKGROUND OF THE INVENTION

1. Field of the Invention

The invention relates generally to hand guided vibratory machines and, more particularly, relates to a vibratory machine with monolithic handle mount that reduces the transmission of vibrations to the operator. The invention additionally relates to a method of operating such a machine.

2. Discussion of the Related Art

Many hand guided machines employ vibratory action. Examples of such machine include vibratory plates or tampers for compacting soil and vibratory wet screeds for leveling and smoothing freshly poured concrete. While these various machines may differ in purpose and function, they all employ a vibratory generator to impart vibrations to a work piece such as a ground-engaging plate or shoe or a concrete-engaging blade.

One specific example of a known hand guided vibratory machine is a vibratory wet screed. The vibratory wet screed employs an elongated blade that extends over a surface of freshly poured wet concrete. A motor, mounted above the blade, activates a vibration generator, which in turn imparts a vibration through the elongated blade. An operator grasps a handle extending above the elongated blade, and pulls the vibrating elongated blade over the concrete surface while simultaneously walking backwards. As a result, the vibratory action of the blade smoothes and levels the wet concrete.

Prior to the introduction of the vibratory wet screed, the process of screeding wet concrete was a manual task. Manual wet screeding typically involved at least two laborers dragging opposite ends of an elongated piece of two-by-four lumber board over a rough surface of wet concrete. Additional laborers would shovel and rake the concrete into position ahead of the approaching screeding board, to ensure that no voids or shallow areas remained in the smooth surface of the concrete after the screeding board had passed. This manual wet screeding process is labor intensive, requiring at least two individuals positioned at opposite ends to drag the screeding board. On average, this manual process would limit a crew of six laborers to pouring and screeding a slab of 6,000 to 8,000 square feet per day. Furthermore, this manual approach is time consuming, physically fatiguing, and often results in uneven or inconsistence results, due in part to the lack of vibration imparted onto the wet concrete surface. Additionally, manual manipulation of concrete typically requires additional water to be added to the concrete mixture, as to increase the workability of the uncured concrete product. However, increasing the water component results in both prolonged curing times as well as increases the presence of voids or weaknesses within the resulting cured concrete slab.

As a result of the many disadvantages of manual wet screeding, the use of vibratory wet screed machines has become an industry standard. However, operation of vibratory wet screed machines presents drawbacks of their own. Most notably, the vibration produced by the vibration generator is not localized to the elongated blade, but rather is transmitted throughout the entire wet screed machine, including through the handle mounts to the handle. According to this undesirable vibration, an individual operating a vibratory wet screed may become fatigued after operating the vibratory wet screed for a prolonged period of time. To ensure that operators are not exposed to such fatiguing effects, regulatory and standard setting agencies in the United States, Europe, and elsewhere have issued guidelines relating to the operation of vibrating tools. These guidelines indicate that machines which impart a hand-arm vibration (HAV) value of 5.0 or greater onto the operator must comply with additional reporting requirements and operating limitations.

To reduce this undesired vibration, some vibratory wet screed machines utilize resilient mounting components between the handle mounts and the screed blade and/or at other locations in the vibrational path from the screed blade to the handles to insulate the handles from vibration. However, these resilient mounting components reduce the ability of the operator to adequately control the pitch, direction and rotation of the elongated blade. Specifically, the “give” of these elements leads to movement of the handles relative to the screed blade, resulting in a reduction in responsiveness. Furthermore, these additional components add unnecessary weight to the machine. Added weight is undesirable because it is generally preferable to make vibratory wet screeds and other hand guided machines as light as possible to reduce operator effort.

Despite these prior attempts to limit the transmission of vibrations to the handles of hand operated vibratory machines, there remains need for improvement. In light of the foregoing, a handle mount configured to reduce the transmission of vibration originating in the vibration generating component of the portable hand operated machine is desired.

### SUMMARY OF THE INVENTION

One or more of the above-identified needs are met by providing an improved handle mount for use in a vibratory machine that reduces the transmission undesirable vibrations to the machine's handles. The apparatus is ideally suited for use with vibratory wet screeds, but is usable with other vibratory hand operated machines as well such as tampers and vibratory plate compactors.

In accordance with a first aspect of the invention, a handle mount is configured for mounting on a portable vibratory machine having a vibration generator that produces a vibration along an attached workpiece. The handle mount comprises a monolithic element having a partial coil located along its length. The partial coil is flanked by a lower section mounted at least indirectly to the workpiece, and an upper section at least indirectly bears a handgrip for use by the operator. The partial coil effectively acts a spring that reduces the transmission of vibrations originating at the vibration generator.

In accordance with another aspect of the invention, the monolithic handle mount may include additional curved elements, allowing the handgrips to be positioned in an ergonomically preferred location for the use of the operator.

The partial coil and any additional curved elements may further provide a protective guard protecting the side of the machine's engine. Furthermore, the additional curved elements may effectively orient the partial coil to lie in a preferred plane to maximize vibration reduction in that plane.

In accordance with yet another aspect of the invention, a method of operating a vibratory hand operated machine is provided having a vibration absorbing handle mount located between the vibration generator and the handle grips that are held by the operator.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which:

FIG. 1 is a front plan view of a hand guided vibratory machine constructed in accordance with a preferred embodiment of the invention;

FIG. 2 is a perspective view of the machine of FIG. 1;

FIG. 3 is a right-side elevation view of the machine of FIG. 1 with an operator;

FIG. 4 is a partially exploded perspective view the machine of FIG. 1;

FIG. 5 is a perspective view of a lower handle mount of a handle assembly of the machine of FIGS. 1-4, viewed from in front of, below, and from the left side of the handle mount;

FIG. 6 is a front elevation view of the handle mount of FIG. 5;

FIG. 7 is a graph indicating the HAV measured at the upper section of the of the lower handle mount of various embodiments, including a preferred embodiment of the invention;

FIG. 8 is a graph indicating the HAV measured at both the lower section and the upper section of the of the lower handle mount, in accordance with a embodiment known in the prior art, and

FIG. 9 is a graph indicating the HAV measured at both the lower section and the upper section of the of the handle mount, in accordance with a preferred embodiment of the invention.

### DETAILED DESCRIPTION OF THE PREFERRED EMBODIMENT

A wide variety of handle mounts for vibrating hand operated machines could be constructed in accordance with the invention as defined by the claims. Hence, while the preferred embodiments of the invention will now be described with reference to a portable vibratory wet screed machine, it should be understood that the invention is in no way so limited. For instance, it is also usable with a variety of different portable vibratory machines that are potentially subject to undesired vibration transmission through the handle.

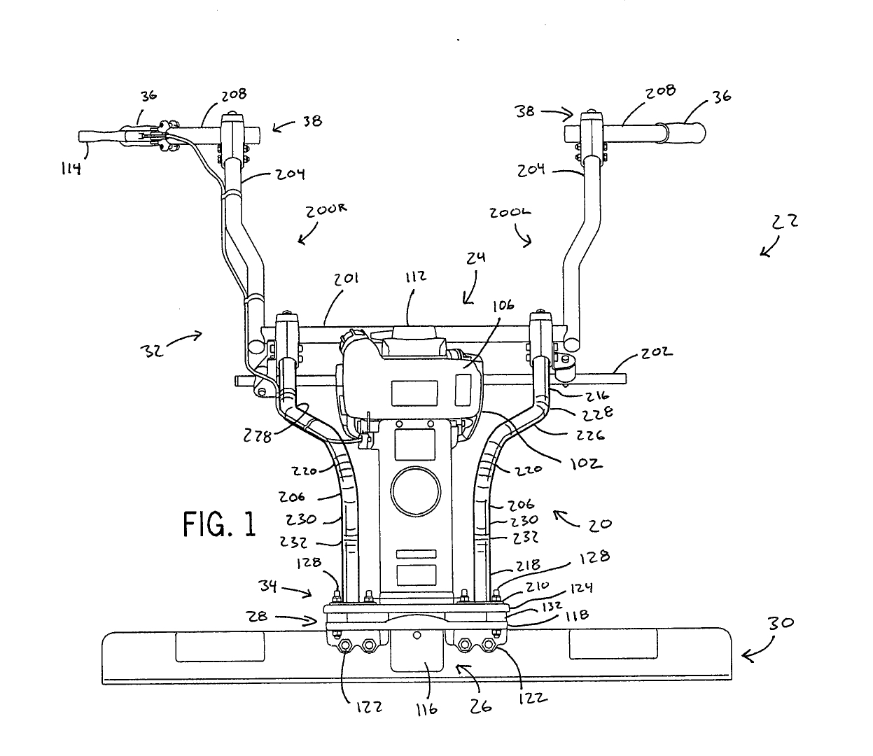

FIG. 1 illustrates a front plan view of a handle 20 constructed in accordance with one embodiment of the invention. Generally, the vibratory wet screed machine 22 includes an engine 24 coupled to a vibration generator 26. The vibration generator 26 typically includes an eccentric mass that is driven to rotate by an output shaft of the engine 24. The engine 24 and vibration generator 26 are mounted on a frame 28 located at a center of an elongated blade 30. A handle assembly 32 is attached to the frame 28 at its lower end 34, and terminates in handgrips 36 at its upper end, located at its upper section 38. In operation, the elongated blade 30 is passed over a freshly poured wet concrete surface as vibrations are imparted to the blade 30 by the engine 24 and the vibration generator 26, thus leveling and partially smoothing the wet concrete. Blade 30 orientation and movement are controlled by an operator 40 grasping the handle assembly 32.

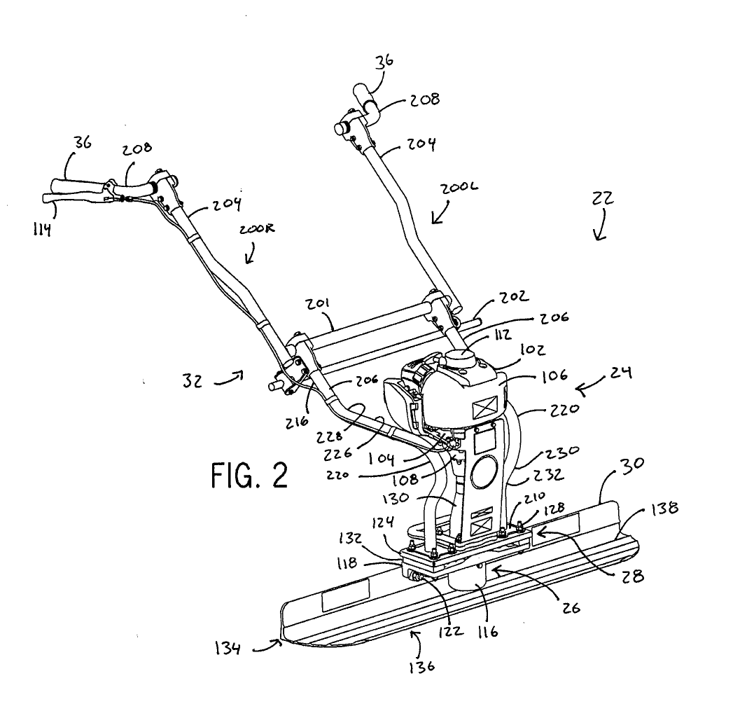

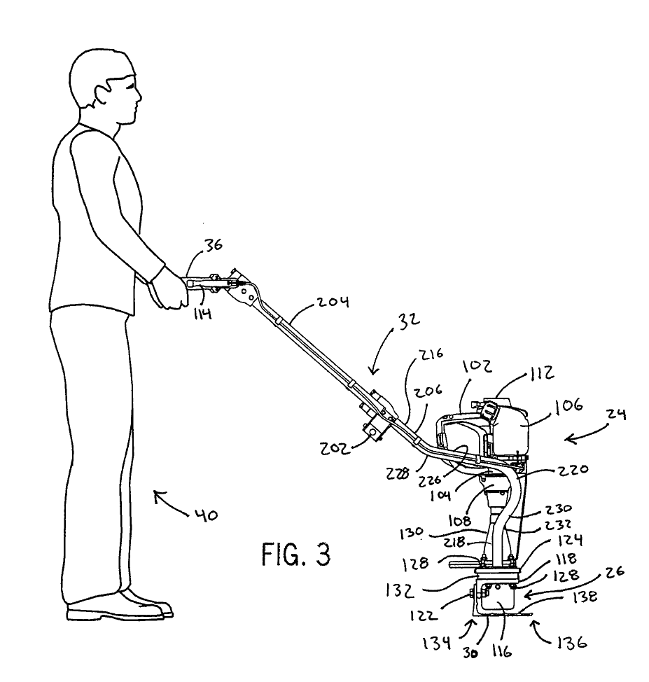

The engine 24 of this exemplary embodiment, as seen in FIGS. 1-4, is a 4-stroke internal combustion engine of the type generally used for vibratory wet screeds. The engine 24 includes an engine block 102, crankcase 104, fuel tank 106, clutch housing 108, and carburetor (not shown). A clutch is coupled to a drive shaft (not shown), which in turn is coupled to the input shaft 110 of the vibration generator 26. The engine 24 may also include a starter 112. Engine speed is controlled by an externally located throttle actuation lever 114.

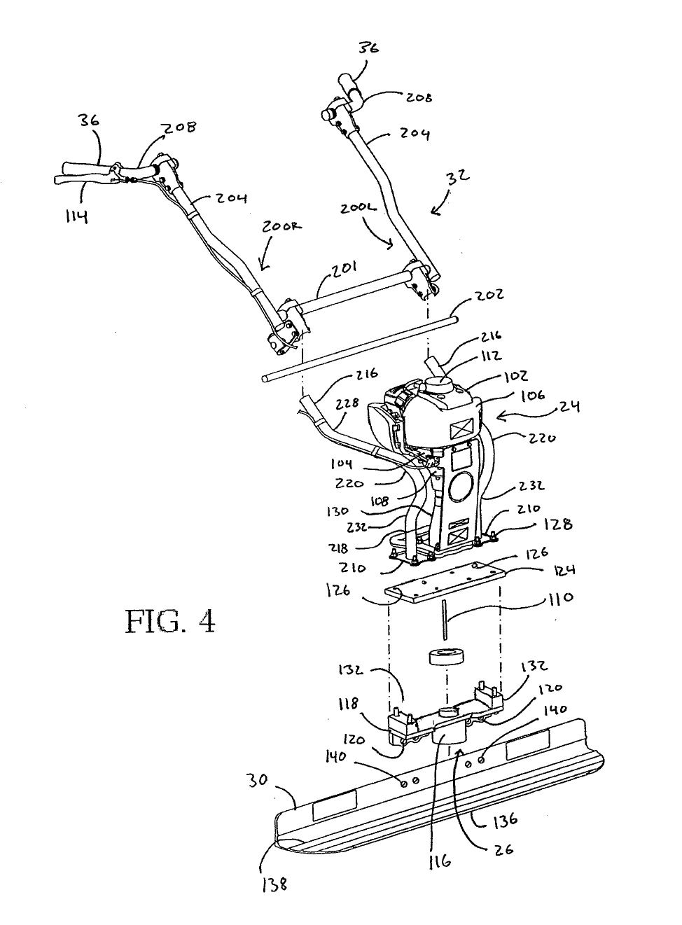

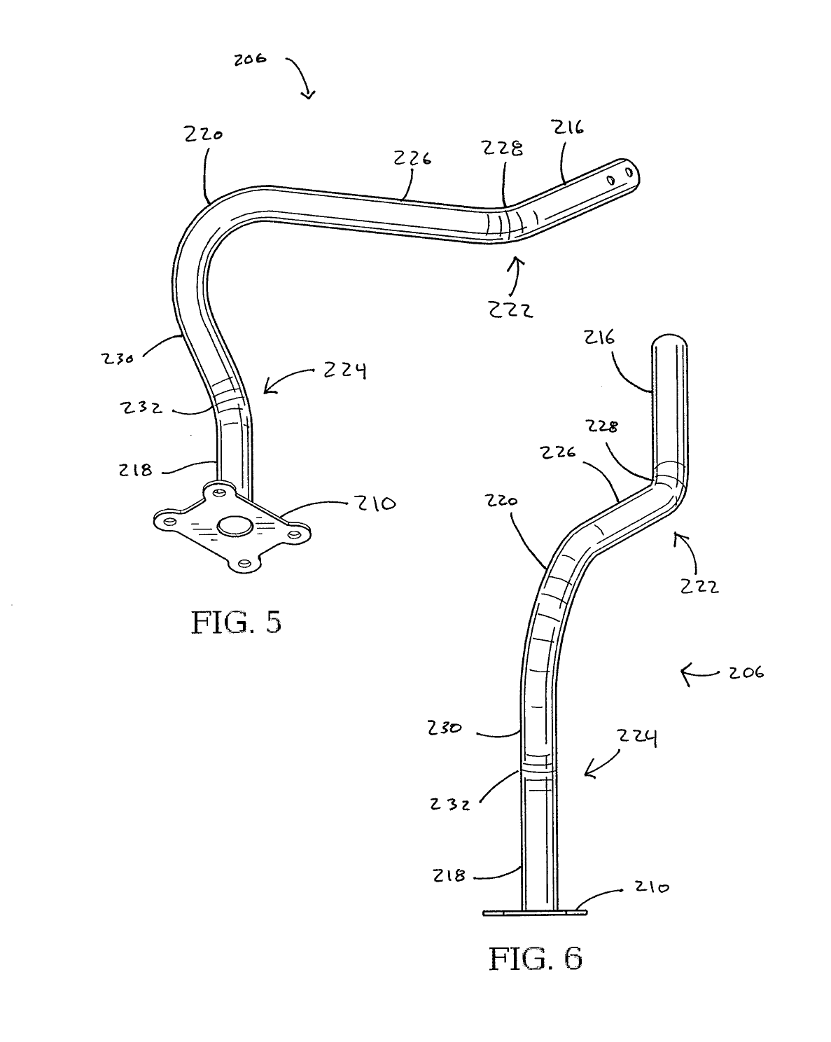

Referring especially to FIG. 4; the vibration generator 26 of the illustrated embodiment preferably includes an imbalance functionally coupled to the input shaft 110. The input shaft 110 is rotationally coupled to the drive shaft of the engine 24 at a flex joint (not shown). The imbalance of the vibration generator 26 may consist of a either adjustable or fixed weights contained within an external housing 116.

As mentioned above, the engine 24 and vibration generator 26 of an illustrated embodiment are coupled to the elongated blade via a frame 28. Referring to FIG. 4, the frame 28 includes a support bracket 118 that is fastened to the upper surface of the screed blade and extends in a forward-aft plane above the screed blade 30. The support bracket 118 has a series of apertures 120 configured to receive fastener elements 122 such as bolts therein. The upper surface of the support bracket 118 is configured to receive a mounting plate 124 thereon. The mounting plate 124 also includes a series of apertures 126, located at positions consistent with those of the support bracket 118, such that fastener elements 128 could pass through both aperture sets and couple the support bracket 118 to the mounting plate 124. The engine 24 is received on the center of the upper surface of the mounting plate 124, and may be supported by the shaft housing 130. In this configuration, the vibration generator 26 extends below the support bracket 118, such that it is in indirect operational engagement with the elongated blade 30 by way of the support bracket 118. Additionally, the mounting plate 124 extends laterally beyond the engine 24, thereby providing a handle assembly 32 mounting surface disposed on either side of the engine 24. A pair of vibration inhibitors 132 are located between the support bracket 118 and the engine mounting plate 124 in order to absorb undesirable vibrations originating at the vibration generator 26, located below the support bracket 118. The vibration inhibitors 132 of this embodiment take the form of two rectangular rubber pads or shock mounts that extend the width of the frame 28. They may have a Durometer rating of 50.

As previously indicated, and illustrated in FIGS. 1-3, the elongated blade 30 is affixed to the engine 24, vibration generator 26 and handle assembly 32 via the support bracket 118. The blade 30 or screed of this embodiment is formed from extruded aluminum and is of an L-shaped cross section, having a vertical portion at a leading edge 134 thereof and a horizontal portion that extends forwardly from vertical portion to a trailing edge 136. The leading edge 134 of the elongated blade 30, i.e. that edge which first engages the freshly poured wet concrete, is positioned along the rear of the vibratory wet screed 22, and is directed nearest the location of the operator 40. The trailing edge 136 of the elongated blade 30 is positioned along the front of the vibratory wet screed, farthest from the location of the operator 40. The horizontal portion of the elongated blade 30 may be comprised of flat surfaces, or may include raised rails 138 to provide additional structural support and additional means for vibration transmission along the length of the elongated blade 30. Mounting holes 140 are formed in the central portion of the vertical portion for receiving the fasteners 122 for the mounting bracket 118.

Referring to FIGS. 1, 2, and 4, the handle assembly 32 of this embodiment includes left and right subassemblies 200L and 200R located on either side of the engine 24 and connected to one another by a cross-bar 201. The handle assembly 32 may further include a pivoting kickstand 202 for supporting the vibratory wet screed machine 22 in an upright orientation when not in operation. Each handle subassembly 200L or 200R includes a handgrip 36, an upper handle mount 204, and a lower handle mount 206. Handles 208 are mounted on the upper ends of the upper handle mounts 204 and receive the handgrips 36. The throttle actuation lever 114 is coupled to one of the handles 208 adjacent the associated handgrips 36. The lower handle mount 206 of each handle assembly 32 terminates in a mounting bracket 210 configured to be attached to a handle assembly-mounting surface of the mounting plate 124, disposed on either side of the engine 24. The mounting bracket 210 is attached to the mounting plate 124 with traditional threaded fasteners 212. The left and right subassemblies 200L and 200R are substantial mirror images of one another. The left lower handle mount 206 will now be detailed, it being understood that the description thereof applies equally to the right handle mount 206.

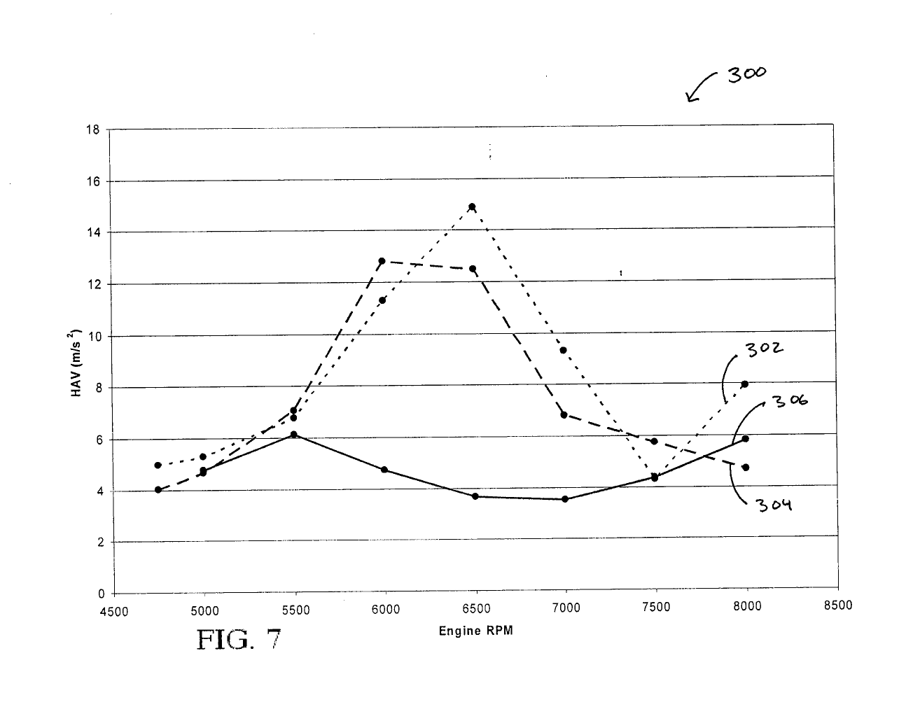

Turning now to FIGS. 6-7, the left lower handle mount 206 takes the form of a monolithic element. A “monolithic element” as used herein means that the element in question (the lower handle mount 206 in the present case) is formed from a single piece without the use of removable fasteners such as bolts or screws. That does not necessarily mean that the element must be formed from a single structure. For example, it could take the form of multiple tubing sections of the same or different materials that are welded together. In the illustrated embodiment, however, the monolithic handle 214 is fabricated of a single continuous piece of hollow metal contoured tube, which is welded to the mounting bracket 210 at the lower section. The tube is contoured by bending to have upper and lower straight sections 216, 218 separated from one another by a partial coil 220 and intermediate segments 222, 224. The partial coil 220 acts as a spring for reducing the transmission of vibrations to the upper straight section 216. The upper intermediate segment 222 includes a short straight section 226 at the upper end of the partial coil 220 and a curved section 228 that serves as a “break” that assures that the associated short straight section 226 is non-tangential to the partial coil 220. Similarly, the lower intermediate segment 224 includes a short straight section 230 at the lower end of the partial coil and a curved section 232 that serves as a “break” that assures that the associated short straight section 230 is non-tangential to the partial coil 220. Specifically, the combination of the partial coil 220, curved sections 228, 232 and interposed short straight sections 226, 230 within the monolithic handle 214 results in forming of an indirect path of vibration travel between the vibration generator 26 and the operator 40. This collective shape of the monolithic handle 214 further changes the mode shape of the system, moving excitation frequencies out of the range of operation of the engine 24 for the application. These intermediate segments 222, 224 also assure that the upper and lower section 216, 218 of the lower handle mount 206 are oriented in a manner that assures alignment of the mounting bracket 210 with the mounting plate 124 and also assure extension of the upper handle mount 204 in a direction that assures the desired ergonomic positioning of the handle 208 and handgrips 36.

The partial coil 220 includes a curvature having a radius of approximately 3.0 inches. The partial coil 220 is oriented such that it exhibits a degree of leaf spring-like flexibility while in operation, sufficient for reducing the transmission of vibrations along the handle assembly 32. The partial coil 220 simultaneously exhibits a significant degree of rigidity as to allow the static load of the machine 22 to be transmitted to the handgrips 36 without deflection and not inhibit an operator's manipulation of the machine 22. The partial coil 220 is oriented such that it lies in and effectively dampens two axes of undesired vibration, namely the vertical axis of the machine 22 and the fore-and-aft axis of the machine 22. It is also considered within the scope of the invention that the partial coil 220 additionally could be oriented to lie in a third axis of undesired vibration, namely the longitudinal axis of the machine 22. Such undesirable vibration may originate in the vibration generator 26 and/or the engine 24. The partial coil 220 of the illustrated embodiment exhibits a spring constant of approximately 0.80 kg/mm along the fore-and-aft axis of the machine 22, 0.76 kg/mm along the longitudinal axis of the machine 22, and 0.40 kg/mm along the vertical axis of the machine 22. The partial coil 220 of the illustrated embodiment exhibits an arc length maximized to suppress undesirable vibration without sacrificing maneuvering control. That arc length is 149.8 mm at the centerline of the monolithic handle 214, in the illustrated embodiment, but could vary significantly, such as between 75 and 250 mm. That arc angle is 112.3 degrees in the illustrated embodiment, but could vary significantly, such as between 75 and 200 degrees. Accordingly, the illustrated embodiment of the partial coil 220 will sufficiently suppress vibrations oriented in the along a vertical axis and a fore-and-aft axis of the machine 22, without imparting significant reduction on operator 40 steering torque. This reduction in undesirable vibrations will result in diminished occurrence of fatigue experienced by an operator 40. The intermediate curved segments 222, 224 may, if desired, also have a radius of approximately 3.0 inches, hence facilitating fabrication by permitting the use of the same bending tool to form all curved sections. However, the arc length of the additional curved segments 222, 224 can be much less than that of the partial coil 220, as see in FIGS. 6-7. In an illustrated embodiment, the arc length of the upper intermediate curved segments 222 is 46.3 mm at the centerline of the monolithic handle 214, and has an arc angle of 34.8 degrees. In the illustrated embodiment, the arc length of the lower intermediate curved segments 224 is 46.7 mm at the centerline of the monolithic handle 214, and has an arc angle of 35.1 degrees. However, various alternative arc angles and arc lengths of the intermediate curved segments 222, 224 are considered within the scope of this invention. The section of the handle mount 206 between the bottom end of the lower curved section 232 to the upper end of the upper curved section 228 preferably has a length of about 350 mm.

It should be noted that the partial coil 220 and intermediate curved segments 222, 224 of the handle mount 206 also serve as a guard that extends along the sides of the engine 24, thereby preventing damage to the engine 24 if the screed machine 22 were to fall or be placed on its side when not in operation. Also, the intermediate curved segment 222 located between the partial coil 220 and the upper section 216 may direct the handle mount 206 upwards, to provide an ergonomic orientation of the handle 208 and handgrips 36, for engagement by the operator 40.

In operation, an operator 40 starts the engine 24, and engagement of the clutch causes the drive shaft to rotate. Manipulating the throttle actuation lever 114 adjusts the operating speed of the engine drive shaft, which ranges from 4,000 to 8,000 rpm, and more preferably 6,000 to 7,000 rpm in standard operating conditions. The rotation of the drive shaft causes the input shaft 110 of the vibration generator 26 to rotate. The input shaft 110 then rotates the imbalance located within the vibration generator 26 to produce vibrations. The vibrations are transmitted to elongated blade 30 and propagate through the blade 30 in a generally sinusoidal pattern. These vibrations typically have a magnitude of about 9-13 HAV at standard engine operating speeds of, e.g., 6,500 rpm. Some of these vibrations are transmitted to the mounting plate 124 through the support bracket 118 and thence to the lower section 34 of the handle assembly 32, i.e. the lower section 218 of the lower handle mounts 206. However, a substantial portion of those vibrations are damped by the partial coils 220 in the lower handle mounts 206. The magnitude of the vibrations induced by the vibration generator 26 are proportional to the speed at which the engine 24 drive shaft rotates. In addition to generating increased vibrations in the vibration generator 26, an engine 24 running at high speed may also form significant vibration that will be distributed throughout the vibratory wet screed 22. Specifically, an engine 24 operating at a speed greater than 6,000 rpm may impart a vibration of between 2.0 and 3.0 HAV into the mounting plate 124 and thus to the lower ends of the lower section 218 of the lower handle mounts 206. Accordingly, at optimal operating speed, the partial coil 220 of the handle mounts 206 may suppress vibrations originating in the engine 24, as well as those vibrations originating in the vibration generator 26.

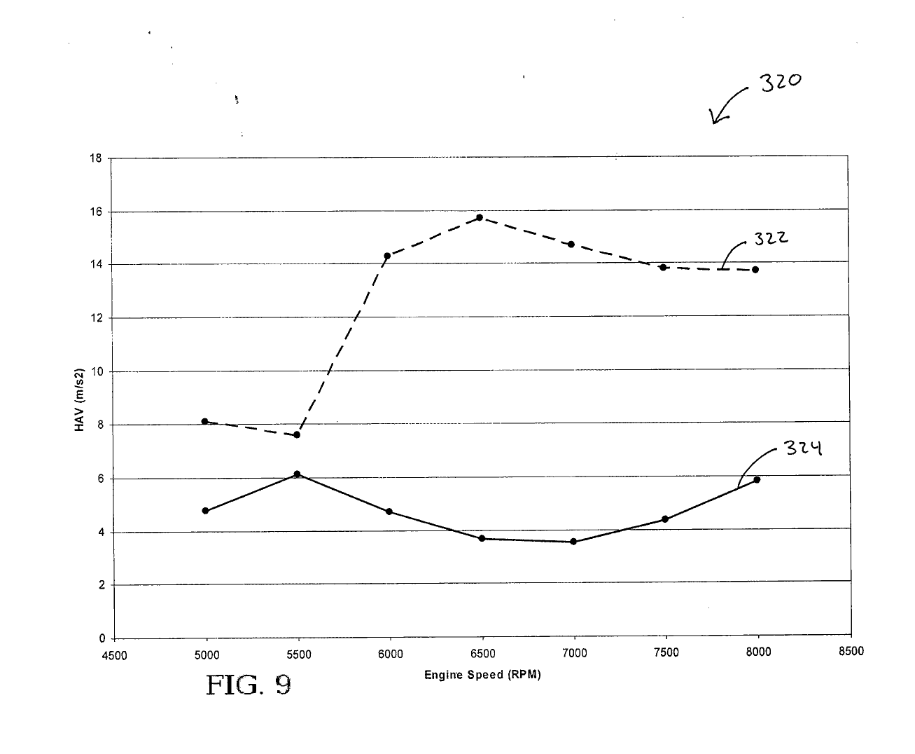

Tests have confirmed that that partial coil 220 of each lower handle mount 206 is capable of significantly reducing the transmission of vibrations transmitted to the lower handle mount 206 by the vibration generator 26 and the engine 24. In fact, assuming an input vibration at the lower section 218 of the lower handle mounts 206 of 14 HAV, tests have shown that the vibrations at the upper section 216 of the lower handle mounts 206 are reduced to less than 10 HAV. In fact, those vibrations are reduced to less than 7 HAV and even less than 5 HAV. In these tests, the engine 24 was operated at a series of operational speeds. At these specified operational speeds, hand-arm vibration (HAV) values were measured first at the location of the lower section 34 of the handle assembly 32, i.e. the lower section 218 of the lower handle mount 206. A second set of HAV values was measured at the location of the handgrips 36, i.e. upper section of the handle 208. The operational speed of the engine 24 was recording in rotations per minute (rpm) and the hand-arm vibration value was measure in units of meters per second squared (m/ŝ2). The results of this test are reflected in tabular form in Table 1 and graphically in FIGS. 7 and 9. Specifically, FIG. 7 includes graph 300, which depicts the HAV values measured at the location of the handgrips 36, over an engine 24 operational speed ranging from 5,000 rpm to 8,000 rpm. Dashed line 302 represents the vibrations measured at the handgrips 36 for a vibratory wet screed comprising relatively straight lower handle mounts, lacking a partial coil 220, as is known in the prior art. Broken line 304 represents the vibrations measured at the handgrips 36 for an alternative vibratory wet screed embodiment comprising lower handle mounts, incorporating a 4.0 inch radius within the prior art design using a relatively straight lower handle mount. Solid line 306 represents the vibrations measured at the handgrips 36 of the vibratory wet screed 22 of the present invention, comprising a partial coil 220 having a radius of 3.0 inches.

FIG. 9 includes graph 320, which depicts the HAV values measured at the vibratory wet screed 22 of the present invention, over an engine 24 operational speed ranging from 5,000 rpm to 8,000 rpm. Broken line 322 represents the vibration measured at the lower section 218 of the lower handle mount 206. Solid line 324 represents the corresponding vibration measured at the location of the handgrips 36, after the vibrations have been dampened by the partial coil 220.

TABLE 1
Vibration Reduction of Handle Comprising a Partial Coil

| Engine Operational | HAV Value at Lower | HAV Value at Upper |
|---|---|---|
| Speed | Section of Handle | Section of Handle |
| (rpm) | (m/s\hat{ }2) | (m/s\hat{ }2) |
| 5,000 | 8.1 | 4.8 |
| 5,500 | 7.6 | 6.1 |
| 6,000 | 14.3 | 4.7 |
| 6,500 | 15.7 | 3.7 |
| 7,000 | 14.7 | 3.5 |
| 7,500 | 13.8 | 4.4 |
| 8,000 | 13.7 | 5.8 |

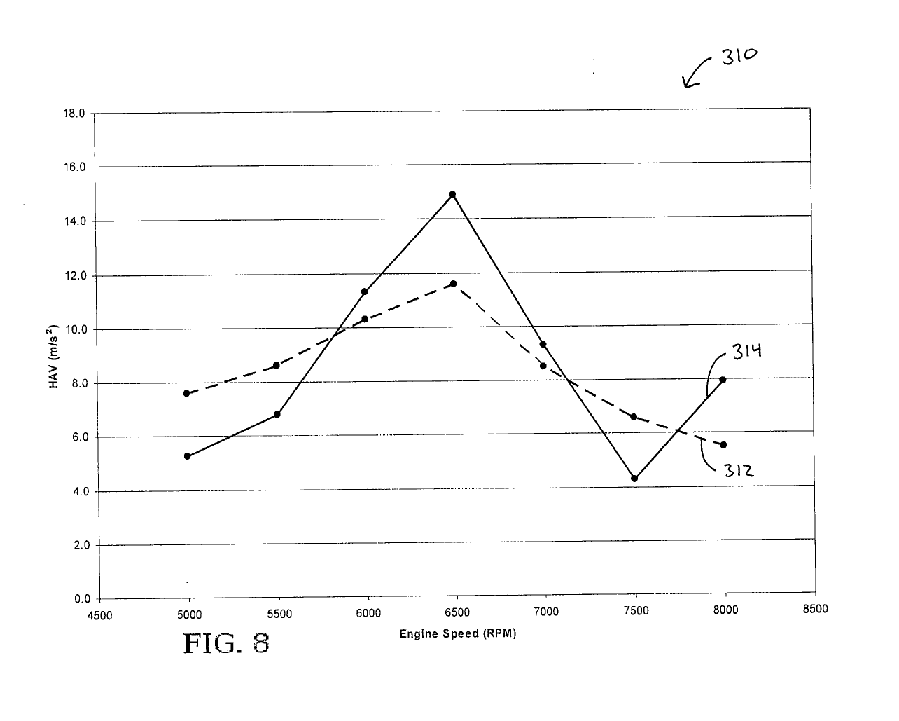

The previous test was then repeated while utilizing a vibratory wet screed comprising relatively straight lower handle mounts, lacking a partial coil, as is known in the prior art. Specifically, the handle had essentially the shape of the handle illustrated in U.S. Pat. No. 7,175,365. The results of this test are reflected in tabular form in Table 2 and graphically in FIGS. 7 and 8. FIG. 8 includes graph 310, which depicts the HAV values measured utilizing a vibratory wet screed comprising relatively straight lower handle mounts, lacking a partial coil, as is known in the prior art, over an engine 24 operational speed ranging from 5,000 rpm to 8,000 rpm. Broken line 312 represents the vibration measured at the lower section of the lower handle mount. Solid line 314 represents the corresponding vibration measured at the location of the handgrips, after the vibrations have been transmitted through the handle assembly.

TABLE 2
Vibration Reduction of Handle Not Comprising
a Partial Coil (Prior Art)

| Engine Operational | HAV Value at Lower | HAV Value at Upper |
|---|---|---|
| Speed | Section of Handle | Section of Handle |
| (rpm) | (m/s\hat{ }2) | (m/s\hat{ }2) |
| 5,000 | 7.6 | 5.3 |
| 5,500 | 8.6 | 6.8 |
| 6,000 | 10.3 | 11.3 |
| 6,500 | 11.6 | 14.9 |
| 7,000 | 8.5 | 9.3 |
| 7,500 | 6.6 | 4.3 |
| 8,000 | 5.5 | 7.9 |

As indicated in Table 1 and by the lines 306 in FIG. 7, the test results show that, when the engine is operated at a speed of between 6,000 and 7,000 rpm, the ideal operating speed of a vibratory wet screed machine, the resulting HAV vibration measured at the handgrips is less than or equal to 4.7 m/ŝ2, for the lower handle mount having a partial coil as described above. Furthermore, the test results from Table 1 indicate that the average reduction in HAV vibration measurement from the lower handle mount, as compared to the handgrip each handle subassembly, is 62.7 percent, over the entire engine operation speed spectrum, for the handle comprising the partial coil. Alternatively, as indicated in Table 2, the test results show that the vibratory wet screed comprising a traditional relatively straight lower handle mount, without a partial coil, exhibited a peak HAV value of 14.9 m/ŝ2 while operating at 6,500 rpm. Furthermore, the test results from Table 2 indicate that the average reduction in HAV vibration measurement from the lower section of the handle, as compared to the upper section of the handle is only 3.6 percent, over the entire engine operation speed spectrum, for the handle comprising the traditional straight handle, without a partial coil. The use of the lower handle mount with the integral partial coil thus reduces vibrations at the upper portions of the handle by 62.7 percent on average and by 75.1 percent at the “sweet spot” of engine operation at 6,500 RPM.

Further tests have confirmed that that partial coil 220 of each lower handle mount 206 is capable of significantly reducing the transmission of vibrations transmitted to the lower handle mount 206 by the vibration generator 26 and the engine 24, while exhibiting decreased deflection in response to operator 40 applied force. In this test, the handle assembly 32 according to the illustrated embodiment of the present invention was fastened to a fixed location at the mounting bracket 210. The height of the handle 208 of the right handle subassembly 200R was then measured to establish a baseline value. In order to simulate the twist motion of an operator trying to maneuver only one side of the blade, weight of 30 lbs. (13.61 kg) was then suspended from the right hand grip of the handle 208, and a deflection distance of 17.0 mm was measured in the handle assembly 32, along the fore-and-aft axis of the machine 22. The test was then repeated with the handle assembly 32 repositioned to measure deflection about the vertical and horizontal axis of the machine 22. The results of these tests are reflected below in Table 3. According to the measurements obtained, the spring constant values of the handle assembly 32, including a partial coil 220, in accordance with the present invention were calculated for each axis of the machine 22. These spring constant values are similarly presented in Table 3.

TABLE 3
Deflection of a Handle Assembly Comprising a Partial Coil

| | Undeflected | Deflected | | |
|---|---|---|---|---|
| | Height of | Height of | Change in | |
| | Handles without | Handles with | Height of | Spring |
| Axis of | Weight | Weight | Handles | Constant |
| Deflection | (mm) | (mm) | (mm) | (kg/mm) |
| Longitudinal | 782.0 | 764.0 | 18.0 | 0.76 |
| Fore-And- | 730.0 | 713.0 | 17.0 | 0.80 |
| Aft | | | | |
| Vertical | 1628.0 | 1594.0 | 34.0 | 0.40 |

The test was then performed while utilizing the handle assembly of a vibratory wet screed comprising relatively straight lower handle mounts, lacking a partial coil, as is known in the prior art. Specifically, the handle assembly had essentially the shape of the handle illustrated in U.S. Pat. No. 7,175,365. After being fastened to a fixed location, the height of the handle was measured to establish a baseline value. A weight of 30 lbs. (13.61 kg) was then suspended from the handgrip of the right handle subassembly, and a deflection distance of 27.0 mm was measured in the handle, along the fore-and-aft axis of the machine.

The test was then repeated with the handle assembly repositioned to measure deflection about the vertical and horizontal axis of the machine. The results of these tests are reflected below in Table 4. According to the measurements obtained, the spring constant values of the handle assembly, comprising relatively straight lower handle mounts, lacking a partial coil, as is known in the prior art were calculated for each axis of the machine. These spring constant values are similarly presented in Table 4.

TABLE 4
Deflection of the Handle Assembly Not
Comprising a Partial Coil (Prior Art)

| | Undeflected | Deflected | | |
|---|---|---|---|---|
| | Height of | Height of | Change in | |
| | Handles without | Handles with | Height of | Spring |
| Axis of | Weight | Weight | Handles | Constant |
| Deflection | (mm) | (mm) | (mm) | (kg/mm) |
| Longitudinal | 771.0 | 755.0 | 16.0 | 0.85 |
| Fore-And- | 700.0 | 673.0 | 27.0 | 0.50 |
| Aft | | | | |
| Vertical | 1730.0 | 1708.0 | 22.0 | 0.62 |

Resultantly, this test demonstrates that the handle assembly 32 of the present invention, incorporating a partial coil 220, exhibits a 37.0 percent decrease in deflection in the direction of operator pull, i.e. fore-and-aft axis of the machine 22, as compared to relatively straight lower handle mounts, lacking a partial coil, as is known in the prior art. This decreased deflection along the fore-and-aft axis is consistent with the greater fore-and-aft axis spring constant exhibited in the present invention. In operation, the diminished deflection in the direction of operator pull is realized through improved maneuverability of the machine 22, according to the present invention. Moreover, the handle assembly 32 of the present invention exhibits a lower spring constant along both the longitudinal and vertical axis of the machine 22, as compared to the relatively straight lower handle mounts, lacking a partial coil.

Many changes and modifications could be made to the invention without departing from the spirit thereof. For instance, the handle assembly may be composed entirely of the monolithic handle, or may alternatively the monolithic handle may be combined with additional handle assembly components. The invention is also applicable to vibratory rammers, portable plate compactors, pneumatic vibrators and other similar portable vibratory hand operated machines, which would benefit from reduction in undesirable vibration transmission through a handle as provided in the current invention. The scope of other changes and modifications will become apparent from the appended claims.

1. A machine comprising:
a workpiece;
a vibration generator that imparts vibration to the workpiece; and
a handle assembly having a handgrip configured to be engaged by an operator and having a monolithic handle mount including
a lower section mounted at least indirectly on the workpiece;
an upper section at least indirectly bearing the handgrip; and
an intermediate section disposed between the lower section and the upper section, the intermediate section providing at least one partial coil that reduces a transmission of the vibration, produced by the vibration generator, to the upper section.

2. The machine of claim 1, wherein the machine is a vibratory screed and the handle mount is mounted at least indirectly on a blade of the vibratory screed.

3. The machine of claim 1, wherein the at least one partial coil reduces the transmission of the vibration in a plane of vibration oriented along a vertical axis of the machine.

4. The machine of claim 3, wherein the at least one partial coil reduces the transmission of the vibration in a plane of vibration oriented along a fore-and-aft axis of the machine.

5. The machine of claim 1, wherein the partial coil is joined at least indirectly to the upper and lower sections by additional curved segments, each of which has a different curvature than a curvature of the partial coil.

6. The machine of claim 5, wherein a first of the curved segments is disposed between the partial coil and the upper section and has a different curvature than a curvature of the upper section, and a second of the curved segments is disposed between the partial coil and the lower section and has a different curvature than a curvature of the lower section.

7. The machine of claim 1, wherein the partial coil is disposed between a first linear length and a second linear length, wherein the first and second linear lengths are nontangential to the partial coil.

8. The machine of claim 1, wherein the at least one partial coil provides a protective guard adjacent a side surface of an engine that drives the vibration generator of the machine.

9. The machine of claim 1, wherein the at least one partial coil provides a spring constant value of between 0.6 kg/mm and 1.2 kg/mm along a fore-and-aft axis of the machine.

10. The machine of claim 1, wherein the monolithic handle mount is formed from a single piece of bent metal tubing.

11. The machine of claim 1, wherein the partial coil has a radius of approximately 3.0 inches.

12. The machine of claim 1, wherein the handle assembly comprises a first subassembly of a larger handle assembly that additionally includes a second handle subassembly that is spaced from the first handle subassembly, the second handle subassembly having a handgrip configured to be engaged by an operator and having a monolithic handle mount having a partial coil therein.

13. The machine of claim 12, wherein the vibration generator is disposed between the first and second handle subassemblies.

14. The machine of claim 1, wherein an upper handle mount is disposed between the monolithic handle mount and the handgrip.

15. The machine of claim 1, wherein the machine is a wet screed and the work piece is a screed blade.

16. A method of reducing vibration transmission in a vibratory machine handle mount, comprising the steps of:
activating a vibration generator to impart vibrations to a workpiece;
grasping a handgrip connected at least indirectly to a first end of a monolithic handle mount of a handle assembly, a second end of the handle mount being mounted at least indirectly to the workpiece; and
absorbing vibrations, transmitted to the lower end of the handle mount through the work piece, in at least one partial coil disposed within the handle mount between the first end and the second end.

17. The method of claim 16, wherein a vibration received at the handgrip has a hand arm vibration value of less than 5.0 m/ŝ2 in response to a vibration generator operational speed of between 6,000 and 7,000 rotations-per-minute.

18. The method of claim 16, wherein a vibration received at the handgrip has a hand arm vibration value of less than 7.0 m/ŝ2 when a vibration received at the lower end has a hand arm vibration value of greater than 14.5 m/ŝ2.

19. The method of claim 18, wherein a vibration received at the handgrip has a hand arm vibration value of less than 5.0 m/ŝ2 when a vibration received at the lower end has a hand arm vibration value of greater than 14.5 m/ŝ2.

20. The method of claim 16, wherein the step of absorbing the vibration further comprising the steps of:
absorbing a least one plane of vibration produced at the vibration generator oriented along a vertical and forward-aft axis of the vibration machine.

21. A method of reducing vibration transmission in a vibratory machine handle mount, comprising the steps of:
activating a vibration generator to impart vibrations to a workpiece;
grasping a handgrip connected at least indirectly to a first end of a monolithic handle mount of a handle assembly, a second end of the handle mount being mounted at least indirectly to the workpiece; and
absorbing vibrations, transmitted to the lower end of the handle mount through the work piece, in at least one partial coil disposed within the handle mount between the first end and the second end, further comprising the steps of:
applying a weight to the vicinity of a handgrip of the handle assembly, the weight having a value of about 13.61 kg; and
in response to the application of the weight, deflecting the handle assembly so that a final height of the handgrip is no more than about 27.0 mm below an initial handgrip height.

22. A vibratory screed comprising:
a screed blade;
a vibration generator that imparts vibrations to the screed blade; and
a handle assembly having a handgrip configured to be engaged by an operator and having a monolithic handle mount formed from a single piece of bent metal tubing and including a lower section, an upper section, and an intermediate section, wherein
the lower section is mounted at least indirectly on the screed blade, the lower section including a first straight section and a first curved section disposed between the first straight section and the intermediate section,
the upper section at least indirectly bears the handgrip and includes a second straight section and a second curved section disposed between the second straight section and the intermediate section,
the intermediate section provides at least one partial coil that acts as a spring that reduces a transmission of the vibrations, produced by the vibration generator, to the upper section, the partial coil having a curvature that is different than a curvature of either that of the first curved section or that of the second curved section, and wherein,
the first and second straight sections are non-tangential to the partial coil.
